(19) United States
(12) Patent Application Publication
(10) Pub. No.: US 2026/0310603 A1
(43) Pub. Date: Oct. 8, 2026

(54) MULTI-TIERED GLOBAL CACHE

(71) Applicant: Hewlett Packard Enterprise Development LP, Spring, TX (US)

(72) Inventors: Clarete Riana Crasta, New York, NY (US); John L. Byrne, Pasadena, CA (US); Abhishek Dwaraki, Pearland, TX (US); David R. Emberson, Santa Cruz, CA (US); Harumi Kuno, Cupertino, CA (US); Sekwon Lee, Austin, TX (US); Sharad Singhal, Belmont, CA (US); Ramya Bangalore Ahobala Rao, Bangalore (IN); Shreyas Vinayaka Basri K S, Bangalore (IN); Amitha Chandrachari, Bangalore (IN); Chinmay Ghosh, Bangalore (IN); Rishi Kesh Kumar Rajak, Bangalore (IN); Sriram Ravishankar, Bangalore (IN); Porno Shome, Bangalore (IN)

(21) Appl. No.: 19/243,430

(22) Filed: Jun. 19, 2025

(30) Foreign Application Priority Data
Apr. 8, 2025 (IN) 202511034562

(51) Int. Cl. G06F 12/0811; G06F 12/0866

(52) U.S. Cl. CPC G06F 12/0811; G06F 12/0866

(57) ABSTRACT

One aspect of the instant disclosure provides a cache system for a computer cluster comprising a plurality of nodes. The cache system may include a global cache distributed over a subset of nodes of the computer cluster. A respective node in the subset contributes a portion of local storage resource to the global cache and runs a cache-manager process to: receive a request for a piece of data; determine whether the requested data is present in the global cache; responsive to locating the requested data in the portion of local storage resource contributed to the global cache by a contributing node, retrieve the requested data by accessing the local storage resource of the contributing node; and respond to the request using the retrieved data.

### RELATED APPLICATION

This application claims the benefit of Indian Provisional Application No. 202511034562, Attorney Docket Number HPE-P176945INPRV, entitled “GLOBAL DISTRIBUTED CLIENT-SIDE CACHE FOR DAOS,” by inventors Clarete Riana Crasta, John L. Byrne, Abhishek Dwaraki, David R. Emberson, Harumi Kuno, Sekwon Lee, Sharad Singhal, Ramya Bangalore Ahobala Rao, Shreyas Vinayaka Basri K S, Amitha Chandrachari, Chinmay Ghosh, Rishi Kesh Kumar Rajak, Sriram Ravishankar, and Porno Shome, filed 8 Apr. 2025.

### BACKGROUND

### Field

This disclosure relates to a cache system. More specifically, this disclosure relates to a multi-tiered global cache system shared among applications running across a computer cluster.

### Related Art

High-performance computing (HPC) and artificial intelligence (AI) workloads demand efficient handling of petabyte-scale data, where file system access latency can significantly impact performance. Distributed workloads face particular challenges, as they rely on centralized storage systems to share intermediate results across nodes. To address latency issues, modern file systems employ various caching approaches, such as server-side caching and client-side caching. Server-side caching stores frequently accessed data in fast memory (e.g., Dynamic Random-Access Memory (DRAM)) on the file servers, but is limited by the server's memory capacity and network bandwidth. Client-side caching stores frequently accessed data locally (using, e.g., solid state drives (SSDs) or DRAM). However, traditional client-side caching typically restricts data reuse to the local node, limiting the benefits of cache sharing across the entire cluster.

### BRIEF DESCRIPTION OF THE FIGURES

FIG. 1 illustrates an example computer cluster implementing a global cache, according to one aspect of the instant disclosure.

FIG. 2 illustrates an example functional block diagram of a cache manager, according to one aspect of the instant disclosure.

FIG. 3 presents a flowchart illustrating an example application-read operation processed by a global cache, according to one aspect of the instant application.

FIG. 4 illustrates a computer system for facilitating the implementation of a global cache, according to one aspect of the instant disclosure.

FIG. 5 illustrates a computer-readable medium (CRM) that facilitates the implementation of a multi-tiered distributed global cache, according to one aspect of the instant disclosure.

In the figures, like reference numerals refer to the same figure elements.

### DETAILED DESCRIPTION

Existing cache systems are typically siloed—optimized for specific use cases such as application, file system, or object store acceleration—leading to fragmented resource allocation in clusters with heterogeneous workloads and diverse data needs. As accelerators and GPUs become more prevalent, traditional CPU-centric caching is increasingly inadequate. This disclosure addresses these challenges by introducing a client-side, multi-tiered global cache that unifies various memory and storage technologies, facilitates data location queries, and allows compute tasks to co-locate with cached data, thereby reducing latency and improving resource utilization.

As the number of compute nodes in an HPC cluster increases, the aggregated resources available for client-side caching, such as DRAM capacity and network bandwidth, grow proportionally. Providing a shared client-side cache across multiple nodes becomes increasingly advantageous for optimizing data access and reducing redundant storage. According to some aspects of the instant disclosure, the client-side global cache may aggregate diverse storage resources (e.g., DRAM, Non-Volatile Memory Express (NVMe), High Bandwidth Memory (HBM), or Storage Class Memory (SCM)) contributed by multiple nodes within the cluster, including both compute nodes and dedicated memory-server nodes.

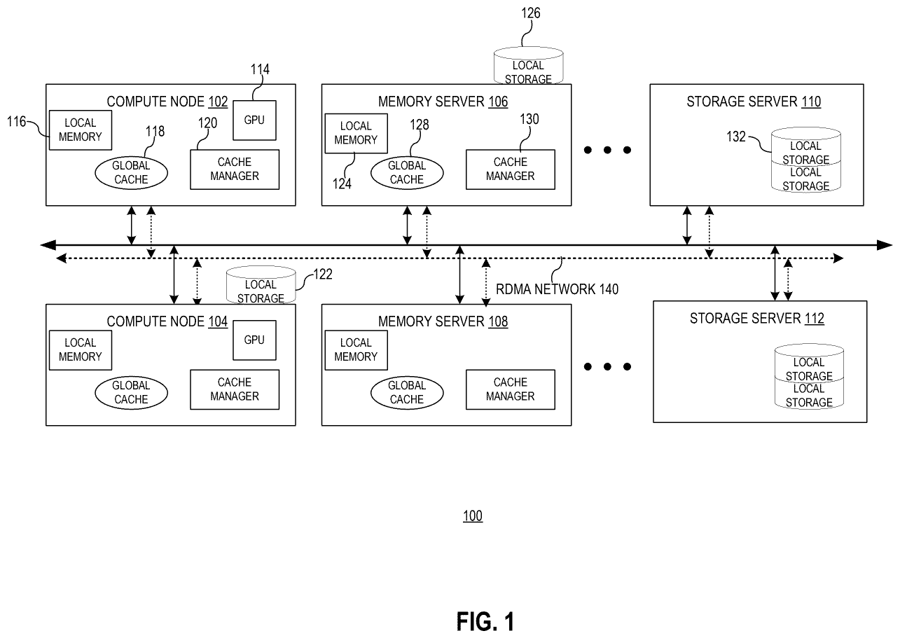

FIG. 1 illustrates an example computer cluster implementing a global cache, according to one aspect of the instant disclosure. A computer cluster 100 may include a plurality of interconnected nodes, such as compute nodes 102 and 104, memory servers 106 and 108, and storage servers 110 and 112.

As used herein, the term “node” may refer to one or more computing devices configured to provide the functions described herein. A “computing device” may be a server, a cluster of servers, a storage array, a computer appliance, a workstation, a desktop computer, a laptop computer, a switch, a router, or any other processing device or equipment including a processing resource. A node may include a processing resource communicatively coupled to at least one non-transitory computer-readable storage medium including instructions that, when executed by the processing resource, cause the node to undertake certain actions and functionalities as described herein.

A compute node may include a dedicated server optimized for executing computational tasks (e.g., data processing, simulation, or application execution). In addition, it may provide a memory pool to a client-side global cache. A memory server may include a specialized server designed to provide large, shared memory pools (e.g., distributed DRAM or SCM) to other nodes in the cluster and to the client-side global cache. The compute nodes and memory servers in the cluster may include different types of storage resources, including but not limited to: persistent memory (e.g., Non-Volatile Dual In-line Memory Modules (NVDIMM) and SCM), SSDs, DRAM, GPU memory (e.g., HBM), and any type of computer-readable storage medium that can offer high data access speeds. The term “storage resource” may refer to memory, disk space, or storage devices (such as HDDs, SSDs, or NVMe drives) available on a specific node within the cluster.

The different types of storage resources may be organized into multiple tiers, with the top tier providing the highest speed. In one example, the top tier (or Tier 1) may include DRAM and GPU memory, the second tier (or Tier 2) may include persistent memory like SCM and NVDIMM, the third tier (or Tier 3) may include SSDs, and the bottom tier (or Tier 4) may include large-capacity persistent storage (e.g., hard drives). In a further example, each type of storage resource may form a distinct tier within the cache. The storage resources may be used to store instructions, data, application files, temporary files, logs, backups, and any information related to the operations of the node.

In the example shown in FIG. 1, compute node 102 includes a GPU 114 and local memory 116. Compute node 102 may contribute a portion of local memory 116 to the global cache, and this contribution is represented as a global-cache portion 118 residing on compute node 102 in FIG. 1. Compute node 104 is similar to compute node 102 but includes an extra local storage module 122, which may include SSDs. Compute node 104 may contribute a portion of its local memory and/or local storage module 122 to the global cache. In some examples, spaces within local storage module 122 (e.g., local SSDs) may function as a spillover area when the global cache exhaust its DRAM capacity. SSDs offer a good balance between the high-speed, limited-capacity DRAM (i.e., the top tier) and the larger-capacity parallel distributed persistent storage tier (i.e., the bottom tier). By leveraging the fast parallel I/O of SSDs, frequently accessed data may be stored and retrieved with reduced latency, enhancing computational throughput. Including local SSDs in the global cache can also achieve cost efficiency, as SSDs provide a lower per-byte cost than DRAM while maintaining performance closer to memory speeds.

Memory server 106 includes local memory 124 and a local storage module 126. Memory server 106 may contribute a portion of local memory 124 and/or local storage module 126 to the global cache, and this contribution is represented as a global-cache portion 128 residing on memory server 106. Memory server 108 is similar to memory server 106 and includes a local memory but without a local storage module. Memory server 108 may contribute a portion of its local memory to the global cache.

Storage servers are designed to store, manage, and provide access to large amounts of data and are built with large storage capacities, often using a plurality of SSDs and hard drives (HDs). In the examples shown in FIG. 1, storage servers 110 and 112 each include an array of local storage modules (e.g., module 132). The storage servers may provide a distributed object store (e.g., Distributed Asynchronous Object Storage (DAOS) or a distributed file system.

The global cache may support high-speed data movement within and across applications via a remote direct memory access (RDMA) network 140, which provides low-latency memory access. As discussed previously, when the DRAM capacity from the various nodes is exceeded, the global cache may seamlessly offload data to locally connected SSDs, reducing overall DRAM requirements while maintaining performance.

The global cache may function as an application cache, allowing data processed by one application to remain in the cache for use by other applications, thereby improving efficiency and reducing redundant data movement. The global cache may also operate as a file system or object store cache with minimal modifications. Different cache policies may be implemented based on the configuration of the global cache. The global cache may provide compatibility with various file systems, such as the Distributed Asynchronous Object Store (DAOS) or the Lustre file system. This flexibility allows the cache to serve as a unified resource for applications running across the cluster.

The global cache may be shared across applications running on different nodes (e.g., compute nodes 102 and 104) within the cluster. More specifically, the global cache may be partitioned, and fractions of the total cache capacity the global cache may be allocated to individual applications based on several factors, including, e.g., a target Quality of Service (QoS) value, a measured QoS value, a target hit rate, and a measured hit rate of an application over a certain time interval. Allocation of the cache capacity to the different applications is beyond the scope of this disclosure.

According to some aspects of the instant disclosure, the global cache may be managed by a distributed cache manager, which is responsible for consolidating the per-node resources of multiple tiers into a unified cache, maintaining awareness of the capacities and access latencies associated with each tier, and implementing appropriate cache policies and data placement algorithms. Using the application cache as an example, the distributed cache manager may be linked with an application and include a process running on each node where the application is running. In the example shown in FIG. 1, each node contributing to the global cache may run a cache-manager process. For example, compute node 102 runs a cache-manager process 120, memory server 106 runs a cache-manager process 130, and so on. The cache-manager processes running on different nodes may be synchronized via cache-manager metadata, which may be stored at a shared storage location accessible to all nodes running the cache-manager process.

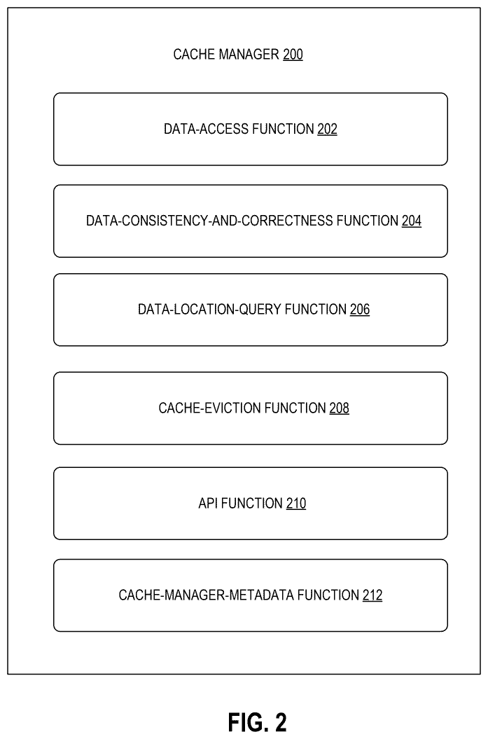

The cache manager may be responsible for coordinating cache capacity and usage across different nodes (e.g., nodes 102-108) and memory/storage tiers (e.g., DRAMs and SSDs). The cache manager may monitor cache usage, handle configuration changes, and dynamically adjust cache capacity to optimize performance and resource utilization. FIG. 2 illustrates an example functional block diagram of a cache manager, according to one aspect of the instant disclosure. A cache manager 200 may include a data-access function 202, a data-consistency-and-correctness function 204, a data-location-query function 206, a cache-eviction function 208, an Application Programming Interface (API) function 210, and a cache-manager-metadata function 212. These functions may be implemented using software, hardware, firmware, or a combination thereof.

Data-access function 202 may employ various mechanisms to access data across different storage and memory tiers. For example, data-access function 202 may use operating system or file system interfaces to access data stored in SSDs, use RDMA to access data in the CPU or GPU memory, and use native APIs to interface with distributed file system (e.g., Lustre) or object stores (e.g., DAOS). Moreover, data-access function 202 may employ advanced data migration strategies to dynamically move data between memory and storage tiers based on real-time access patterns and application performance requirements. Frequently accessed data may be moved to faster memory tiers (e.g., DRAMs or GPU memory), whereas less frequently used data may be moved to slower, more cost-effective storage tiers (e.g., SSDs or HDs). When accessing the GPU memory, data-access function 202 may leverage GPUDirect capabilities (e.g., GPUDirect RDMA or GPUDirect storage), where supported, for efficient data transfers between the GPU memory and the global cache.

According to some aspects, data-access function 202 may integrate and adapt functionalities developed for fabric-attached memory (FAM) systems (e.g., functionalities provided by the OpenFAM framework) into the caching layer. OpenFAM provides efficient access to network-attached (also referred to as “fabric-attached”) memory using RDMA over various high-performance networks, including Ethernet, Slingshot, and InfiniBand. Within the OpenFAM architecture, each node runs a memory manager responsible for managing its local memory contributions to the global FAM pool. Such a memory manager may be used to manage the local memory portion contributed to the global cache.

Data-consistency-and-correctness function 204 may be responsible for ensuring data consistency and correctness to allow the global cache to function according to the expected semantics of the underlying object store or file system. Data-consistency-and-correctness function 204 may enforce data consistency using mechanisms including but not limited to: dirty bit tracking, cache invalidations, and metadata updates.

When the global cache is configured as an application cache, all data accesses may be handled by cache manager 200, obviating the need for invalidation, since the cache manager has complete control over all data. However, when the global cache is configured as a file system cache, the underlying data may change due to external accesses outside the application or cache manager 200. In such cases, invalidation mechanisms are provided to maintain data consistency.

According to some aspects, data-consistency-and-correctness function 204 may provide invalidation mechanisms tailored to application requirements or the underlying storage system. More specifically, data-consistency-and-correctness function 204 may provide multiple configurable invalidation mechanisms, such as a mechanism to automatically invalidate cached data in response to notifications of changes in the underlying storage and a mechanism to invalidate cached data based on a Time-to-Live (TTL) policy, which ensures that stale data can be periodically refreshed. These cache invalidation mechanisms ensure that the global cache operates according to the expected semantics of the object store or file system, providing reliable data access in heterogeneous and distributed environments.

Data-location-query function 206 may be responsible for responding to queries about the location of application data within the global cache. By providing accurate and up-to-date information about where specific data resides, data-location-query function 206 allows compute tasks to be co-located with the corresponding data. Such data-aware scheduling may significantly reduce data movement, reduce access latency, and improve overall computational efficiency across the cluster.

Cache-eviction function 208 may be responsible for enforcing a wide range of flexible and configurable eviction policies, ranging from basic approaches like Least Recently Used (LRU) and First-In-First-Out (FIFO) to advanced strategies like Adaptive Replacement Cache (ARC). Additionally, the system is built to accommodate new policies in the future. Applications may specify the desired caching policy by leveraging configuration parameters or API calls.

API function 210 may be responsible for providing a plurality of APIs used to manage the global cache. These APIs may enable efficient data access, caching, and management across multiple nodes and memory/storage tiers. Examples of the APIs may include, but are not limited to, object-management APIs, data-access APIs, metadata APIs, data-location APIs, and directory-management APIs.

The object-management APIs may include at least an open-object API (used to open an object in the global cache, retrieve its metadata, and initialize an object handle for subsequent operations), a close-object API (used to close an object, release associated resources, and update the cache state), and a delete-object API (used to delete an object from the cache and persistent storage, ensuring that all associated metadata and resources are cleaned up).

The data-access APIs may include at least a data-read API, a data-write API, and a preserve-data API. The data-read API may be used to read data from the global cache or underlying storage into a user-provided buffer. Cached data may be dynamically fetched from the appropriate tier (e.g., DRAM, SSD, or persistent storage) based on availability and access patterns. The data-write API may be used to write data to the global cache and to update the appropriate memory tier and metadata. It ensures data consistency and handles block-level updates. The preserve-data API may be used to flush dirty data from the cache to persistent storage, ensuring data durability and consistency.

The metadata APIs may include a get-cache-configuration API (used to retrieve configurations of the global cache, including eviction policies, invalidation mechanisms, block size, and other parameters) and a set-cache-configuration API (used to set the configurations of the global cache).

The data-location APIs include a get-location API used to obtain information about the location of data blocks within the global cache. The data-location information may enable applications consuming the data to optimize data access by co-locating computation with data. For example, a task scheduler may use the get-location API to obtain the location information of data in the global cache and then schedule compute tasks accordingly. Compute tasks requiring access to certain data are scheduled at nodes caching the data.

The directory-management APIs may include a make-directory API used to create a directory in the persistent storage layer and a remove-directory API used to remove a directory from the persistent storage layer.

The above-mentioned APIs are accessible to various frameworks utilizing the global cache, such as a runtime system or a file system client component. APIs used to configure the global cache (e.g., selecting caching policies) may be user-visible. These APIs provide a robust framework for managing the distributed, multi-tiered global cache, enabling efficient data access, consistency, and scalability in heterogeneous HPC and AI environments. Moreover, the configurable APIs allow customization and integration of the global cache with various applications and storage systems, making it adaptable to a wide range of use cases and environments.

Cache-manager-metadata function 212 may be responsible for managing the cache-manager metadata, which may be stored at a shared location accessible to all nodes running the cache-manager process. The cache-manager metadata may include information regarding the content of the global cache, such as the data size and location. The cache-manager metadata may be updated each time a cache-manager process modifies the global cache (e.g., new data being added to the cache or changes being made to the cache capacity).

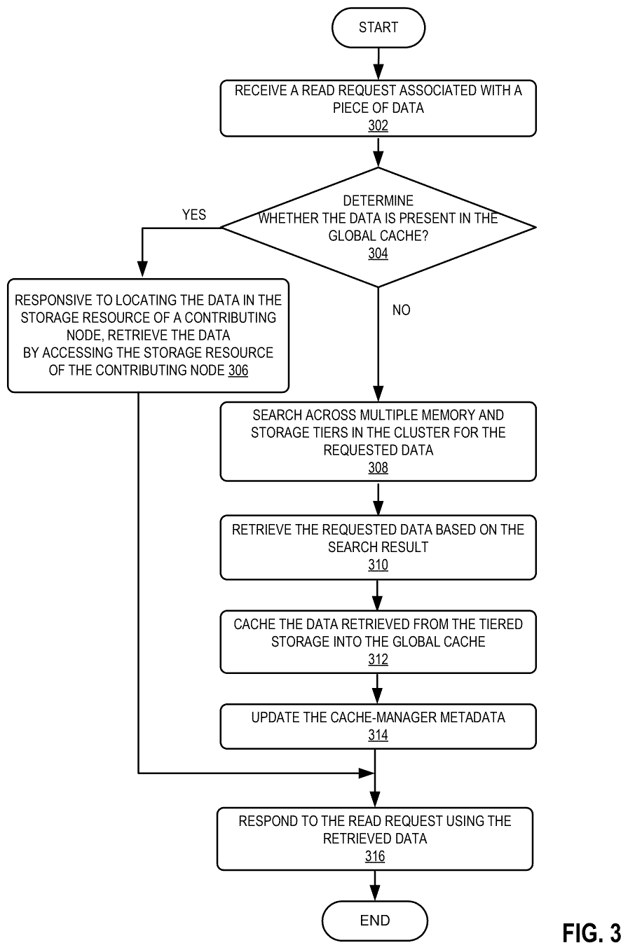

FIG. 3 presents a flowchart illustrating an example application-read operation processed by a global cache, according to one aspect of the instant application. The global cache may be distributed over a subset of nodes in a computer cluster, with each node in the subset contributing a portion of its local storage resource to the global cache. The global cache may include storage resources that may be organized into multiple tiers (e.g., faster or slower tiers) based on the types of the storage resources, including but not limited to DRAM, HBM, SCM, SSD, or any other existing or future memory or storage medium.

During operation, a cache-manager process may receive a read request associated with a piece of data (operation 302). The cache-manager process may be running on a compute node belonging to a computer cluster running one or more applications, such as HPC or AI applications. The cache-manager process may use an API to intercept the read request from an application.

Upon receiving the read request, the cache-manager process may determine whether the requested data is located in the global cache (operation 304). The global cache may be shared by multiple applications running on the cluster across nodes. The cached data may reside on the same node where the cache-manager process intercepts the read request or on a different node that contributes to the global cache. In some examples, the cache-manager process may read the cache-manager metadata, which tracks the content and distribution of the global cache. If the cache-manager metadata indicates that the requested data is present in the global cache, the cache-manager may identify the specific node where the data resides.

Responsive to locating the requested data in the storage resource of a contributing node, the cache-manager process may retrieve the data by accessing the storage resource of the contributing node(operation 306). Depending on the type of storage resource, the cache-manager process may use different data-access mechanisms. In one example, the cached data is stored in the DRAM of a remote node, the cache-manager process may use an RDMA-read operation to retrieve the cached data. If the cached data is stored on a remote node in a tier that is not available via the RDMA operation (e.g., on an SSD), the cache-manager process handling the read request may need to communicate with the cache-manager process running on the remote node to gain access to the data. In one example, the cached data is stored in a distributed object store, the cache-manager process may use the object-store API to access the cached data.

If the requested data is not present in the global cache, the cache-manager process may initiate a search across multiple memory and storage tiers in the cluster (operation 308). The cache-manager process may search the DRAMs, the SSDs (e.g., flash drives) attached to compute nodes in the cluster, and the persistent storage (e.g., persistent object stores) provided by the storage servers. In some examples, the cache-manager process may search faster storage tiers (e.g., DRAMs and SSDs) before the slower storage tiers (e.g., HDs).

Subsequently, the cache-manager process may retrieve the requested data based on the search result (operation 310). Depending on the type of storage resource storing the data, the cache-manager process may use different data-access mechanisms for data retrieval. If the requested data is located on an SSD, the cache-manager process may use the operating or file system interface to access the data.

The cache-manager process may then cache the data retrieved from the tiered storage into the global cache (operation 312). Depending on the utilization of the global cache, the data may be cached at the current node (i.e., the node intercepting the read request) or a different node within the cluster. In some examples, the cache-manager process may first determine whether the global cache on the current node running the cache-manager process is full. If the current node has unused global cache capacity, the cache-manager process may cache the data in the global cache on the current node, thus allowing the cached data to be close to the computation requesting the data. If the global cache portion on the current node is full, the cache-manager process may need to cache the data in the global cache on a remote node. While caching the data, the cache-manager process may enforce data consistency using mechanisms including but not limited to dirty bit tracking, cache invalidations, and metadata updates. The cache-manager process may also enforce a wide range of flexible and configurable eviction policies depending on whether the cache is configured as an application cache, a file system cache, or an object store cache.

Subsequent to caching, the cache-manager process may update the cache-manager metadata, which indicates the location of the cached data (operation 314). Timely update of the cache-manager metadata ensures that further requests can be served efficiently. The cache-manager process may respond to the read request using the retrieved data(operation 316). If the read request is from an application, the retrieved data may be returned to the application via an API.

All or any portion of the operations shown in FIG. 3 may be performed, for example, by the various functions shown in FIG. 2. Although the example process in FIG. 3 shows a specific order for performing certain operations, the process is not limited to such orders. Operations shown in succession in a flowchart may be performed in a different order and may be executed concurrently or with partial concurrence or combinations thereof.

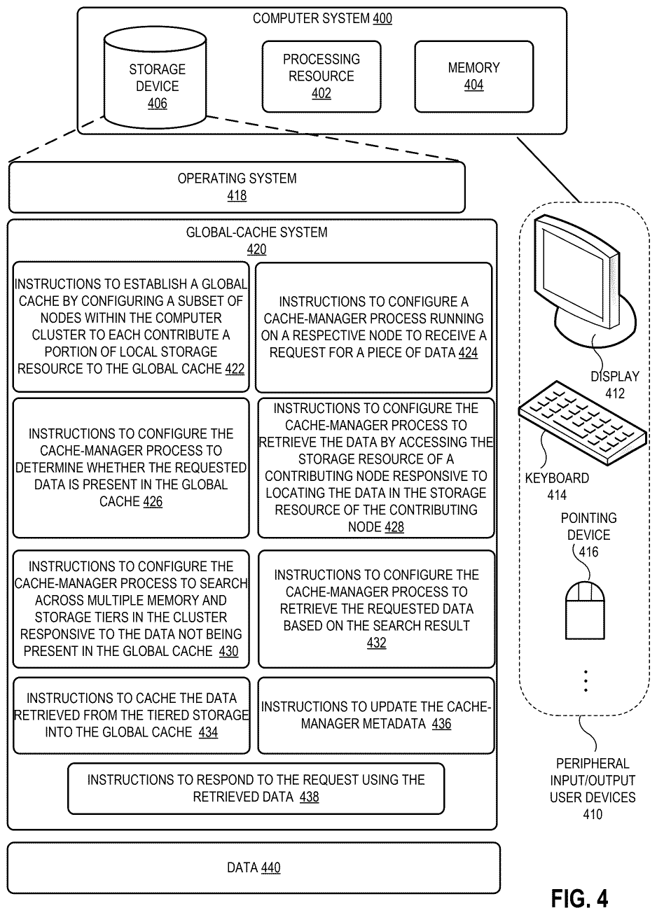

FIG. 4 illustrates a computer system for facilitating the implementation of a global cache, according to one aspect of the instant disclosure. Computer system 400 includes a processing resource 402, a memory 404, and a storage device 406. A portion of memory 404 and/or storage device 406 may be contributed to the multi-tiered global cache. Furthermore, computer system 400 may be coupled to peripheral I/O user devices 410 (e.g., a display device 412, a keyboard 414, and a pointing device 416). Storage device 406 includes a non-transitory computer-readable storage medium and stores instructions of an operating system 418, a global-cache system 420, and data 440. According to some aspects, computer system 400 may be implemented on a node among a plurality of nodes in a computer cluster, such as compute node 102 or 104, or memory server 106 or 108 shown in FIG. 1. Computer system 400 may include fewer or more entities than those shown in FIG. 4.

Global-cache system 420 may include any number of software units, hardware units, and firmware units that work together to achieve the goal of implementing a distributed multi-tiered global cache on the client side. According to some aspects, global-cache system 420 may include instructions that when executed by processing resource 402 cause processing resource 402 to perform methods and/or processes described in this disclosure.

In the examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

According to some aspects, global-cache system 420 may include instructions 422 to establish a global cache by configuring a subset of nodes within the computer cluster to each contribute a portion of local storage resource to the global cache. The local storage resource may include different types of computer-readable medium organized into multiple tiers, including but not limited to DRAM, HBM, SCM, SSD, or any other existing or future computer-readable storage medium. The computer cluster may be running an HPC or AI application requiring data exchange among different nodes within the cluster.

Global-cache system 420 may include instructions 424 to configure a cache-manager process running on a respective node to receive a request for a piece of data, as described above in relation to operation 302 shown in FIG. 3. The cache-manager process may be present on each node running the application and may intercept the application's read requests.

Global-cache system 420 may include instructions 426 to configure the cache-manager process to determine whether the requested data is present in the global cache, as described above in relation to operation 304 shown in FIG. 3. Instructions 426 may include instructions to read the cache-manager metadata, which tracks the content and distribution of the global cache.

Global-cache system 420 may include instructions 428 to configure the cache-manager process to retrieve the data by accessing the storage resource of a contributing node, responsive to locating the requested data in the storage resource of the contributing node, as described above in relation to operation 306 shown in FIG. 3. If the data is cached in the DRAM of a remote node, instructions 428 may include RDMA instructions. If the data is cached in a distributed object store, instructions 428 may configure the cache-manager process to retrieve the cached data via the object-store API,

Global-cache system 420 may include instructions 430 to configure the cache-manager process to search across multiple memory and storage tiers in the cluster for the requested data, responsive to the requested data not being present in the global cache, as described above in relation to operation 308 shown in FIG. 3. The cache-manager process may be configured to search faster storage tiers before slower storage tiers. For example, instructions 430 may configure the cache-manager process to search the DRAM/SSD tier before searching the HD tier.

Global-cache system 420 may include instructions 432 to configure the cache-manager process to retrieve the requested data based on the search result, as described above in relation to operation 310 shown in FIG. 3. Instructions 432 may include RDMA instructions or instructions to use operating system or file system interfaces to retrieve the data.

Global-cache system 420 may include instructions 434 to cache the data retrieved from the tiered storage into the global cache, as described above in relation to operation 312 shown in FIG. 3. Instructions 434 may include instructions to enforce data consistency using mechanisms like dirty bit tracking, cache invalidations, and metadata updates, and instructions to enforce a wide range of flexible and configurable eviction policies.

Global-cache system 420 may include instructions 436 to update the cache-manager metadata, as described above in relation to operation 314 shown in FIG. 3. The cache-manager metadata is stored in a shared location accessible to all nodes in the cluster. Each time a cache-manager process modifies the global cache (e.g., caches new data, evicts stale data, or updates the cache capacity), the cache-manager process may update the cache-manager metadata.

Global-cache system 420 may include instructions 438 to respond to the request using the retrieved data, as described above in relation to operation 316 shown in FIG. 3. Instructions 438 may include instructions to return the data using an API.

Global-cache system 420 may include more instructions than those shown in FIG. 4. For example, global-cache system 420 may include instructions to receive, from a task scheduler, a query for the location of a piece of data associated with a compute task, instructions to read the-cache manager metadata to determine the location of the data based on the cache manager metadata, and instructions to respond to the query with the determined location to allow the task scheduler to schedule the compute task based on the access latency associated with the determined location.

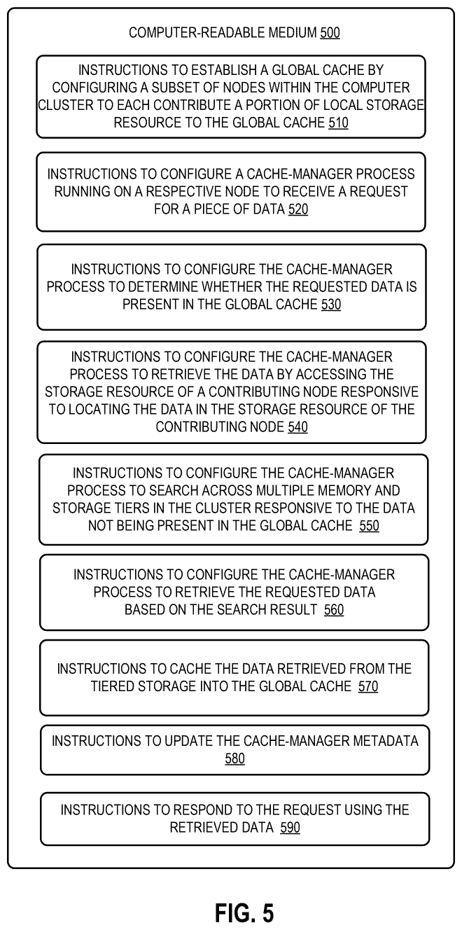

FIG. 5 illustrates a computer-readable medium (CRM) that facilitates the implementation of a multi-tiered distributed global cache, according to one aspect of the instant disclosure. CRM 500 may be a non-transitory computer-readable medium or device storing instructions that when executed by a computer or processing resource cause the computer or processing resource to perform a method. As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 500 may store instructions 510 to establish a global cache by configuring a subset of nodes of the computer cluster to each contribute a portion of local storage resource to the global cache; instructions 520 to configure a cache-manager process running on a respective node to receive a request for a piece of data, as described above in relation to operation 302 shown in FIG. 3; instructions 530 to configure the cache-manager process to determine whether the requested data is present in the global cache, as described above in relation to operation 304 shown in FIG. 3; instructions 540 to configure the cache-manager process to retrieve the data by accessing the storage resource of a contributing node, responsive to locating the data in the storage resource of the contributing node, as described above in relation to operation 306 shown in FIG. 3; instructions 550 to configure the cache-manager process to search across multiple memory and storage tiers in the cluster for the requested data, responsive to the requested data not being present in the global cache, as described above in relation to operation 308 shown in FIG. 3; instructions 560 to configure the cache-manager process to retrieve the requested data based on the search result, as described above in relation to operation 310 shown in FIG. 3; instructions 570 to cache the data retrieved from the tiered storage into the global cache, as described above in relation to operation 312 shown in FIG. 3; instructions 580 to update the cache-manager metadata, as described above in relation to operation 314 shown in FIG. 3; and instructions 590 to respond to the request using the retrieved data, as described above in relation to operation 316 shown in FIG. 3.

CRM 500 may include more instructions than those shown in FIG. 5. For example, CRM 500 may include instructions to receive, from a task scheduler, a query for the location of a piece of data associated with a compute task, instructions to read the-cache manager metadata to determine the location of the data based on the cache manager metadata, and instructions to respond to the query with the determined location to allow the task scheduler to schedule the compute task based on the access latency associated with the determined location.

In general, the disclosure provides a solution to the problem of client-side caching for heterogeneous applications running on computer clusters with different storage and data access requirements. A multi-tiered distributed global client-side cache system may scale up with the number of compute nodes in a cluster by aggregating client-side storage resources. This global cache system may include a plurality of nodes, each contributing a portion of its local storage resource to the global cache shared across applications running across different nodes in a cluster. Each node may run a cache-manager process to access data from different tiers of the global cache, apply cache policies and algorithms for data placement, and ensure data consistency. A task scheduler may query the cache-manager process for data location and schedule the compute task in close proximity to the data to reduce data access latencies.

In the examples described herein, functionalities described as being performed by “instructions” may be understood as functionalities that may be performed by those instructions when executed by a processing resource. In other examples, functionalities described in relation to instructions may be implemented by one or more logic units, which may be any combination of hardware and programming to implement the functionalities of the logic unit(s).

One aspect of the instant disclosure provides a cache system for a computer cluster comprising a plurality of nodes. The cache system may include a global cache distributed over a subset of nodes of the computer cluster. A respective node in the subset contributes a portion of local storage resource to the global cache and runs a cache-manager process to: receive a request for a piece of data; determine whether the requested data is present in the global cache; responsive to locating the requested data in the portion of local storage resource contributed to the global cache by a contributing node, retrieve the requested data by accessing the local storage resource of the contributing node; and respond to the request using the retrieved data.

According to one variation on this aspect, storage resources contributed by the subset of nodes to the global cache are organized into multiple tiers based on types of the storage resources.

According to a further variation, the types of the storage resources may include one or more: dynamic random-access memory (DRAM); high bandwidth memory (HBM); storage class memory (SCM); or solid-state drive (SSD).

According to one variation on this aspect, the cache-manager process is further to: responsive to determining that the requested data is not present in the global cache, search additional storage locations associated with the computer cluster; responsive to locating the requested data at a storage location, retrieve the located data from the storage location; and cache the data retrieved from the storage location in the global cache.

According to a further variation, caching the data may comprise: in response to determining that the global cache on the respective node has unused capacity, caching the data in the global cache on the respective node, and in response to determining that the global cache on the respective node is full, caching the data in the global cache on a remote node.

According to a further variation, the cache-manager process is to update cache-manager metadata accessible to the subset of nodes, the cache-manager metadata indicating a location of the cached data.

According to a further variation, while determining whether the requested data is present in the global cache, the cache-manager process is to read the cache-manager metadata.

According to a further variation, the cache-manager process is to: receive, from a task scheduler, a query for a location of a second piece of data associated with a compute task; determine the location of the second data based on the cache-manager metadata; and respond to the query with the determined location. The task scheduler is to schedule the compute task based on access latency associated with the determined location.

According to one variation on this aspect, the global cache is configured as an application cache, a file system cache, or an object store cache. The cache-manager process is to implement a cache policy based on the configuration of the global cache.

One aspect of the instant disclosure provides a method for implementing a cache system for a computer cluster comprising a plurality of nodes. The method may include establishing a global cache by configuring a subset of nodes within the computer cluster to each contribute a portion of local storage resource to the global cache and configuring a cache-manager process running on a respective node within the subset to: receive a request for a piece of data; determine whether the requested data is present in the global cache; responsive to locating the requested data in the portion of local storage resource contributed to the global cache by a contributing node, retrieve the requested data by accessing the local storage resource of the contributing node; and respond to the request using the retrieved data to the requesting node.

One aspect of the instant disclosure provides a non-transitory computer-readable storage medium storing instructions which when executed by a processor cause the processor to perform a method for implementing a cache system for a computer cluster comprising a plurality of nodes. The method includes establishing a global cache by configuring a subset of nodes within the computer cluster to each contribute a memory portion to the global cache and configuring a cache-manager process running on a respective node within the subset of node to: receive a request for a piece of data; determine whether the requested data is present in the global cache; responsive to locating the requested data in the portion of local storage resource contributed to the global cache by a contributing node, retrieve the requested data by accessing the local storage resource of the contributing node; and respond to the request using the retrieved data.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatuses. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A cache system for a computer cluster comprising a plurality of nodes, the cache system comprising:
a global cache distributed over a subset of nodes of the computer cluster, a respective node in the subset contributing a portion of local storage resource to the global cache and running a cache-manager process to:
receive a request for a piece of data;
determine whether the requested data is present in the global cache;
responsive to locating the requested data in the portion of local storage resource contributed to the global cache by a contributing node, retrieve the requested data from the local storage resource of the contributing node; and
respond to the request using the retrieved data.

2. The cache system of claim 1, wherein storage resources contributed by the subset of nodes to the global cache are organized into multiple tiers based on types of the storage resources.

3. The cache system of claim 2, wherein the types of the storage resources comprise one or more:
dynamic random-access memory (DRAM);
high bandwidth memory (HBM);
storage class memory (SCM); or
solid-state drive (SSD).

4. The cache system of claim 1, wherein the cache-manager process is further to:
responsive to determining that the requested data is not present in the global cache, search additional storage locations associated with the computer cluster;
responsive to locating the requested data at a storage location, retrieve the located data from the storage location; and
cache the data retrieved from the storage location in the global cache.

5. The cache system of claim 4, wherein caching the data comprises:
in response to determining that the global cache on the respective node has unused capacity, caching the data in the global cache on the respective node; and
in response to determining that the global cache on the respective node is full, caching the data in the global cache on a remote node.

6. The cache system of claim 5, wherein the cache-manager process is further to update cache-manager metadata accessible to the subset of nodes, wherein the cache-manager metadata indicates a location of the cached data.

7. The cache system of claim 6, wherein, while determining whether the requested data is present in the global cache, the cache-manager process is further to read the cache-manager metadata.

8. The cache system of claim 6,
wherein the cache-manager process is further to:
receive, from a task scheduler, a query for a location of a second piece of data associated with a compute task;
determine the location of the second data based on the cache-manager metadata;
respond to the query with the determined location; and
wherein the task scheduler is to schedule the compute task based on access latency associated with the determined location.

9. The cache system of claim 1, wherein the global cache is configured as an application cache, a file system cache, or an object store cache, and wherein the cache-manager process is to further implement a cache policy based on the configuration of the global cache.

10. A method for implementing a cache system for a computer cluster comprising a plurality of nodes, the method comprising:
establishing a global cache by configuring a subset of nodes within the computer cluster to each contribute a portion of local storage resource to the global cache; and
configuring a cache-manager process running on a respective node within the subset to:
receive a request for a piece of data;
determine whether the requested data is present in the global cache;
responsive to locating the requested data in the portion of local storage resource contributed to the global cache by a contributing node, retrieve the requested data by accessing the local storage resource of the contributing node; and
respond to the request using the retrieved data.

11. The method of claim 10, wherein storage resources contributed by the subset of nodes to the global cache are organized into multiple tiers based on types of the storage resources, and wherein the types of the storage resources comprise one or more:
dynamic random-access memory (DRAM);
high bandwidth memory (HBM);
storage class memory (SCM); or
solid-state drive (SSD).

12. The method of claim 10, further comprising configuring the cache-manager process to:
responsive to determining that the requested data is not present in the global cache, search additional storage locations associated with the computer cluster;
responsive to locating the requested data at a storage location, retrieve the located data from the storage location; and
cache the data retrieved from the storage location in the global cache.

13. The method of claim 12, wherein caching the data comprises:
in response to determining that the global cache on the respective node has unused capacity, caching the data in the global cache on the respective node; and
in response to determining that the global cache on the respective node is full, caching the data in the global cache on a remote node.

14. The method of claim 13, further comprising configuring the cache-manager process to update cache-manager metadata accessible to the subset of nodes, wherein the cache-manager metadata indicates a location of the cached data, and wherein determining whether the requested data is present in the global cache comprises reading the cache-manager metadata.

15. The method of claim 14, further comprising:
configuring the cache manager to:
receive, from a task scheduler, a query for a location of a second piece of data associated with a compute task;
determine the location of the second data based on the cache-manager metadata; and
respond to the query with the determined location; and
scheduling, by the task scheduler, the compute task based on access latency associated with the determined location.

16. The method of claim 10, wherein the global cache is configured as an application cache, a file system cache, or an object store cache, and wherein the method further comprises configuring the cache-manager process to implement a cache policy based on the configuration of the global cache.

17. A non-transitory computer-readable storage medium storing instructions which when executed by a processor cause the processor to perform a method for implementing a cache system for a computer cluster comprising a plurality of nodes, the method comprising:
establishing a global cache by configuring a subset of nodes within the computer cluster to each contribute a memory portion to the global cache; and
configuring a cache-manager process running on a respective node within the subset of node to:
receive a request for a piece of data;
determine whether the requested data is present in the global cache;
responsive to locating the requested data in the portion of local storage resource contributed to the global cache by a contributing node, retrieve the requested data by accessing the local storage resource of the contributing node to; and
respond to the request using the retrieved data.

18. The non-transitory computer-readable storage medium of claim 17, wherein storage resources contributed by the subset of nodes to the global cache are organized into multiple tiers based on types of the storage resources, and wherein the types of the storage resources comprise one or more:
dynamic random-access memory (DRAM);
high bandwidth memory (HBM);
storage class memory (SCM); or
solid-state drive (SSD).

19. The non-transitory computer-readable storage medium of claim 17, wherein the method further comprises configuring the cache-manager process to:
responsive to determining that the requested data is not present in the global cache, search additional storage locations associated with the computer cluster;
responsive to locating the requested data at a storage location, retrieve the located data from the storage location;
cache the data retrieved from the storage location in the global cache; and
update cache-manager metadata accessible to the subset of nodes, wherein the cache-manager metadata indicates a location of the cached data.

20. The non-transitory computer-readable storage medium of claim 19, wherein the method further comprises:
configuring the cache-manager process to:
receive, from a task scheduler, a query for a location of a second piece of data associated with a compute task;
determine the location of the second data based on the cache-manager metadata; and
respond to the query with the determined location; and
scheduling, by the task scheduler, the compute task based on access latency associated with the determined location.
